(19) United States
(12) Patent Application Publication
(10) Pub. No.: US 2011/0108724 A1
(43) Pub. Date: May 12, 2011

(54) Apparatus, System and Method for Purifying Nucleic Acids

(76) Inventors: Kenneth J. Ewing, Elkridge, MD (US); Danielle N. Dickinson, Odenton, MD (US); Douglas B. Henderson, Columbia, MD (US); Johnny Ho, Clarksville, MD (US)

(21) Appl. No.: 12/967,451

(22) Filed: Dec. 14, 2010

Related U.S. Application Data
(62) Division of application No. 12/213,694, filed on Jun. 23, 2008.

(51) Int. Cl. H01J 49/00

(52) U.S. Cl. 250/282

(57) ABSTRACT

A chemical sample collection and detection system is disclosed. The chemical sample collection and detection system includes a sample collection device and a detection device. The sample collection device includes a housing having two opposite sides and at least one openings on each side to allow a fluid sample passing through the housing; and a sorbent material placed between the two opposite sides of the housing or a sorbent coated screen. The sorbent material adsorbs chemical vapors, and traps particles and aerosols in the fluid sample when the fluid sample passes the housing through the openings. The detection device includes an atmospheric pressure ionization source and an ion detector. The atmospheric pressure ionization source desorbs and ionizes the chemicals trapped/sorbed on the sorbent material and the ion detector analyzes the ions for the presence of the sorbed chemical.

### TECHNICAL FIELD

The embodiments described herein relate generally to sample collection and detection systems, and more particularly, to a chemical sample collection and detection system using atmospheric pressure ionization.

### BACKGROUND

In recent years, there has been demand for devices for detecting chemical threats that may be used in a terrorism attack. The current state-of-the-art vapor sample collection and analysis systems use sorbent tube technology where a sorbent tube containing a packed bed of sorbent material that preferentially adsorbs or binds to a particular class or classes of vapor phase analytes. A large volume of air, typically containing a small amount of analyte, is drawn through the sorbent material bed such that the targeted vapor phase analyte, or analytes, is captured/adsorbed by the sorbent material. Analysis is performed on a highly concentrated plug of sample vapor which is generated by heating the sorbent tube to a temperature where the captured/sorbed analyte is released/desorbed from the sorbent material into a low flow rate stream of inert gas.

This approach, commonly called preconcentration/thermal desorption (P/TD), has several disadvantages: first, thermal decomposition of some thermally labile analytes often leads to poor analytical performance; second, P/TD requires relatively long analysis times because of the thermal dynamics involved in heating the sorbent/tube assembly; third, P/TD is only capable of a single analysis of each captured sample and produces large power draws as a result of the thermal requirements; fourth, packed beds of sorbent can exhibit high pressure drops that require significant pumping and power; and fifth, due to the relatively low flow rates used, P/TD cannot collect and analyze solid and liquid aerosol samples.

### SUMMARY

A method for detecting a chemical in a fluid sample is disclosed. The method includes the steps of: passing a fluid sample through a sorbent material that absorbs chemical vapors, and traps particles and aerosols from the fluid sample; desorbing and ionizing chemicals adsorbed or physically trapped on the sorbent material using an atmospheric pressure ionization technique; and detecting the ions generated by the atmospheric pressure ionization technique.

Also disclosed is a sample collection device. In one embodiment, the sample collection device comprises a housing having two openings; and a thin layer of sorbent material placed inside the housing between the two openings of the housing, wherein the sorbent material adsorbs chemical vapors, and traps particles and aerosols in a fluid sample when the fluid sample passes through the housing via the openings.

Also disclosed is a chemical sample collection and detection system. The chemical sampling and detection system includes a sample collection device for collecting chemical vapors, aerosols and particles in a fluid sample, a detection device for detecting chemicals collected in the sample collection device, and a control device for controlling the system. In one embodiment, the sample collection device includes a housing having two opposite sides and at least one openings on each side to allow the fluid sample passing through the housing, and a sorbent material placed between the two opposite sides of the housing. The sorbent material adsorbs chemical vapors, and traps particles and aerosols in the fluid sample when the fluid sample passes the housing through the openings. The detection device includes an atmospheric pressure ionization source and an ion detector.

### DETAILED DESCRIPTION OF DRAWINGS

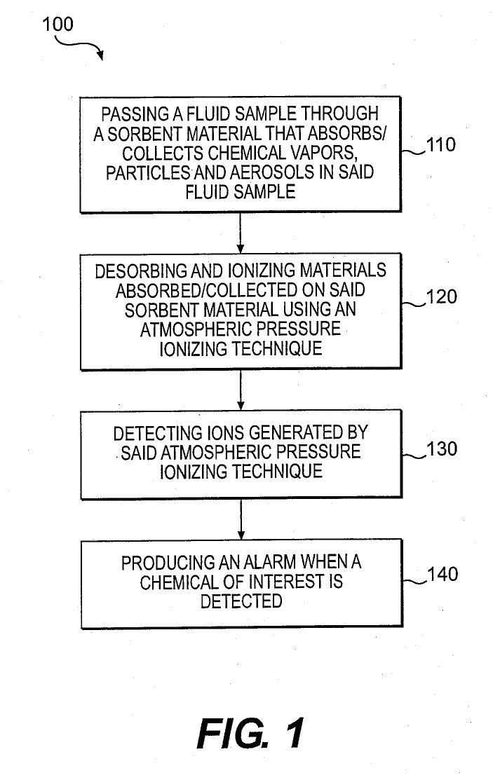

FIG. 1 is a flow chart showing a method for detecting a chemical of interest in a fluid sample.

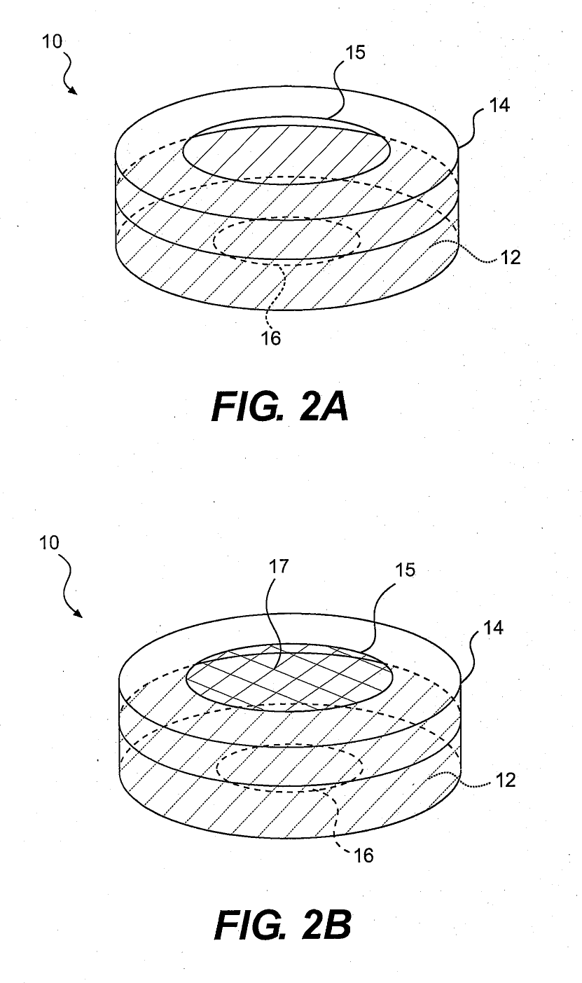

FIGS. 2A and 2B are schematics showing one potential embodiment of a sample collection device.

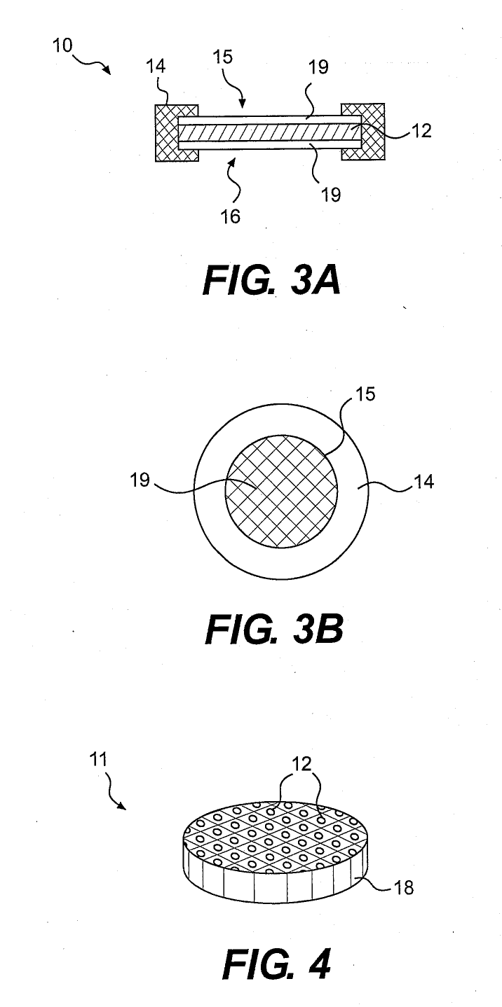

FIGS. 3A and 3B are schematics showing the side view (FIG. 2A) and top view (FIG. 2B) of another embodiment of a sample collection device.

FIG. 4 is a schematic showing a sorbent material cartridge.

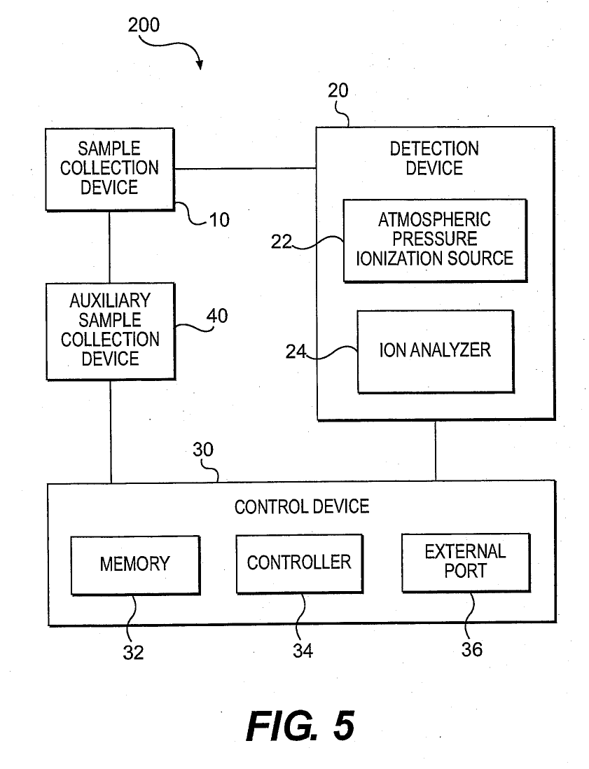

FIG. 5 is a schematic of an embodiment of a chemical sampling and detection system.

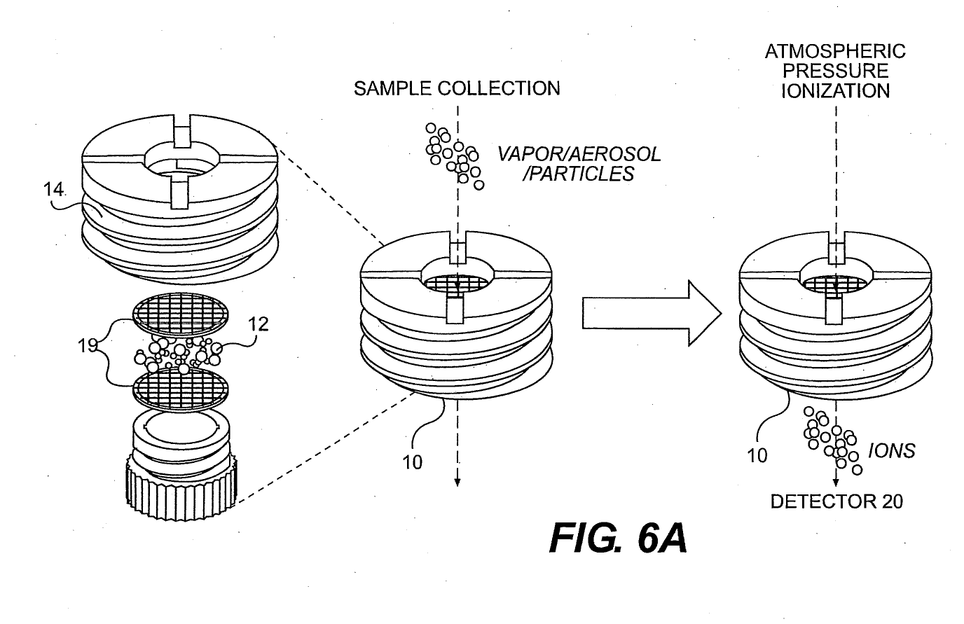

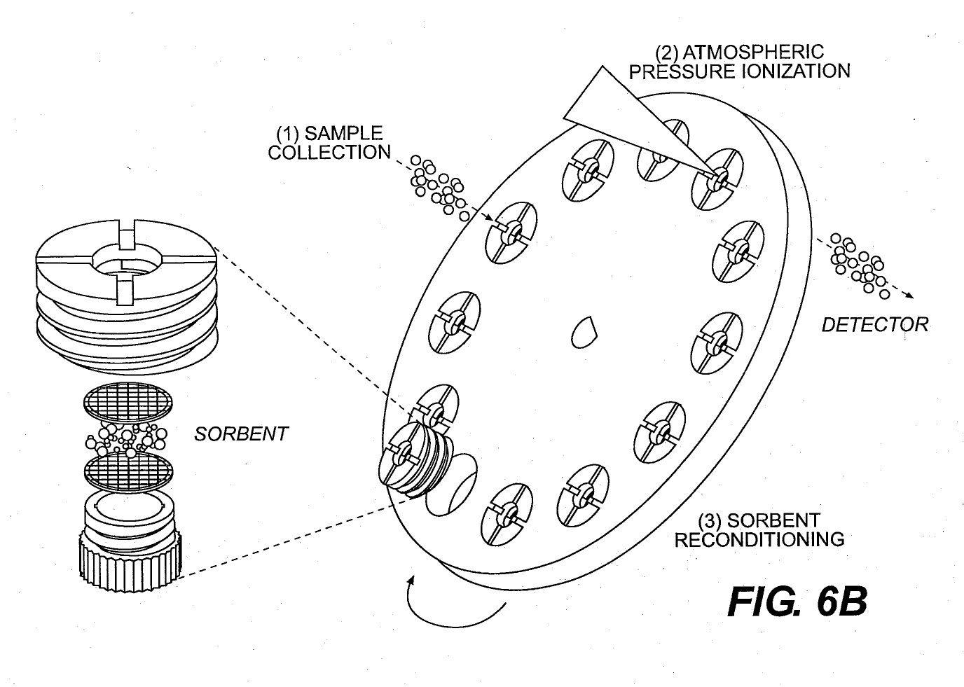

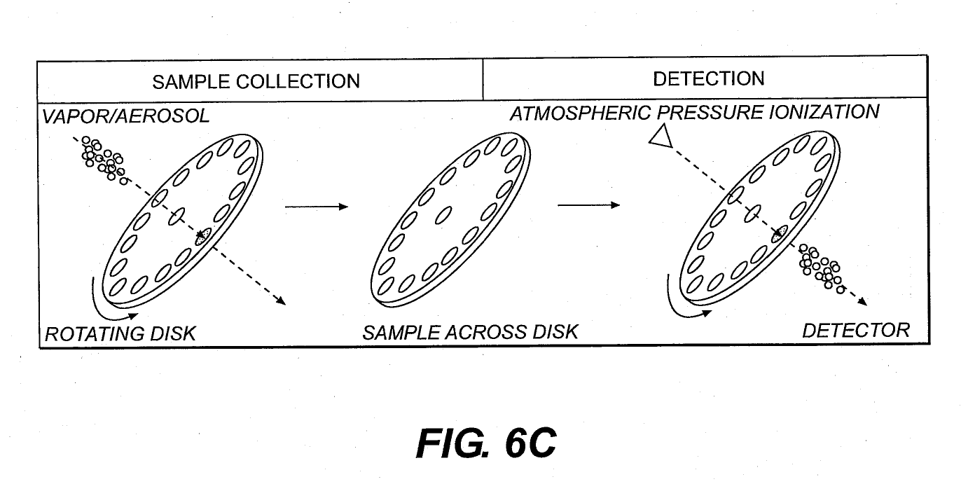

FIGS. 6A, 6B and 6C are schematics showing a sample collection device (FIG. 6A), and a compact disk architecture for an automated, high throughput sample collection and detection system (FIGS. 6B and 6C).

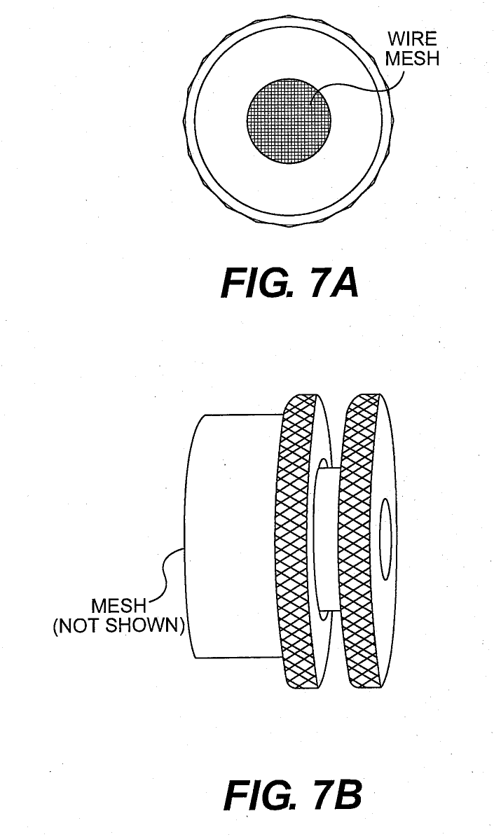

FIGS. 7A and 7B are pictures showing the top view (FIG. 7A) and side view (FIG. 7B) of a prototype sample collection device.

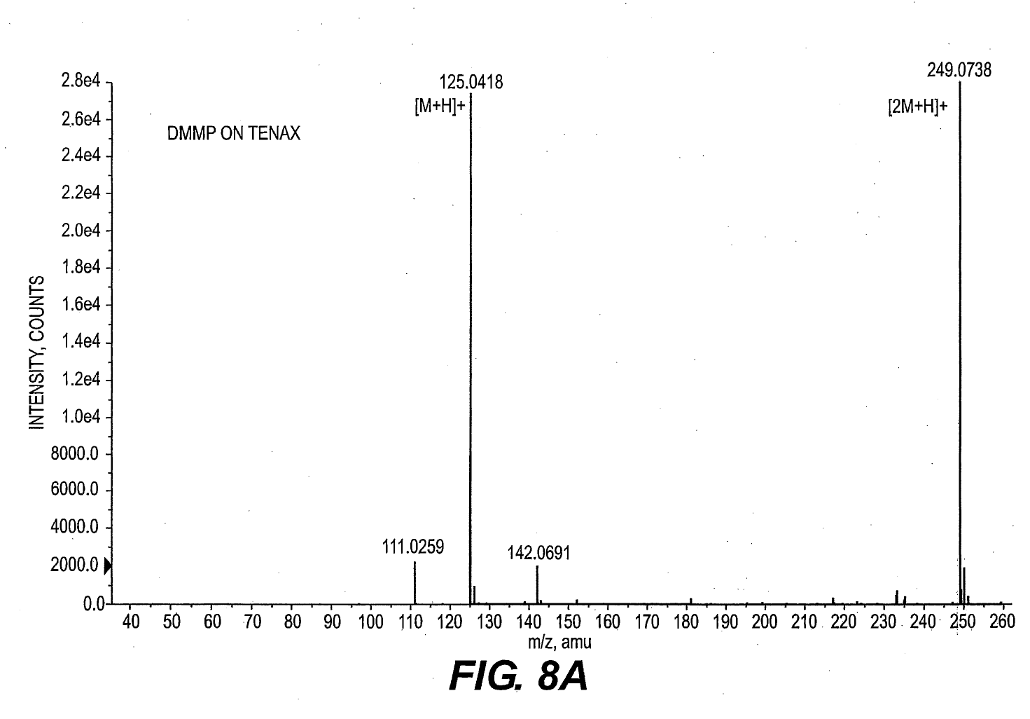

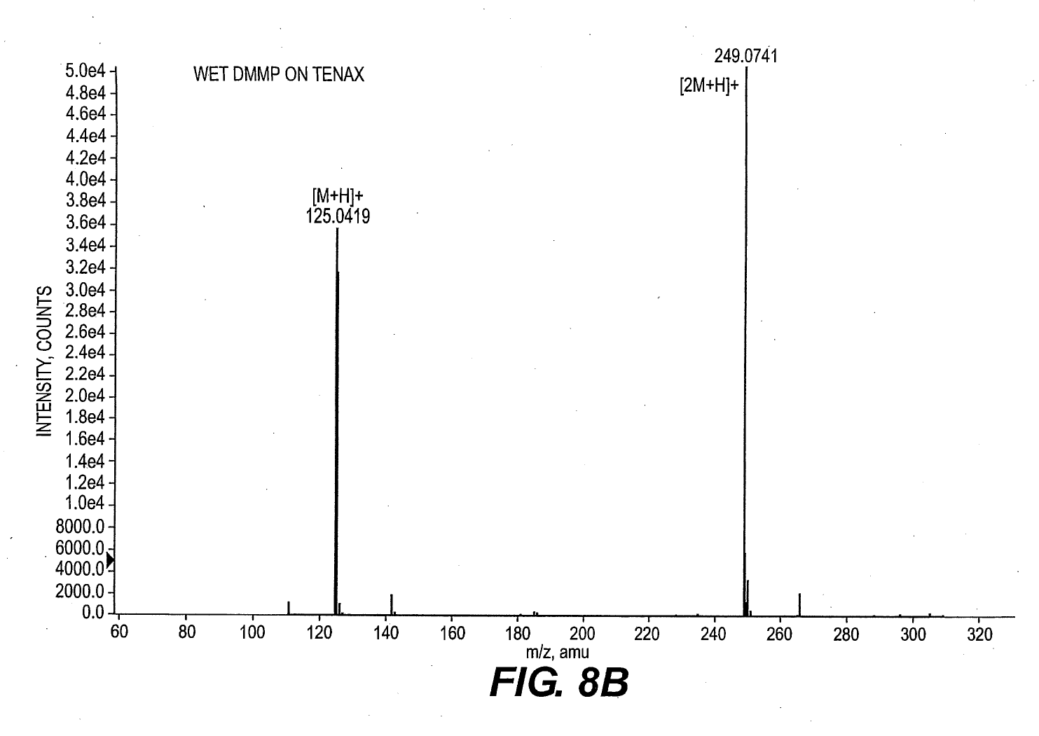

FIGS. 8A and 8B are diagrams showing Direct Analysis in Real Time/Mass Spectrometry (DART/MS) detection of dimethyl methylphosphonate (DMMP) vapor sorbed on dry Tenax TA (FIG. 8A) and wet Tenax TA (FIG. 8B).

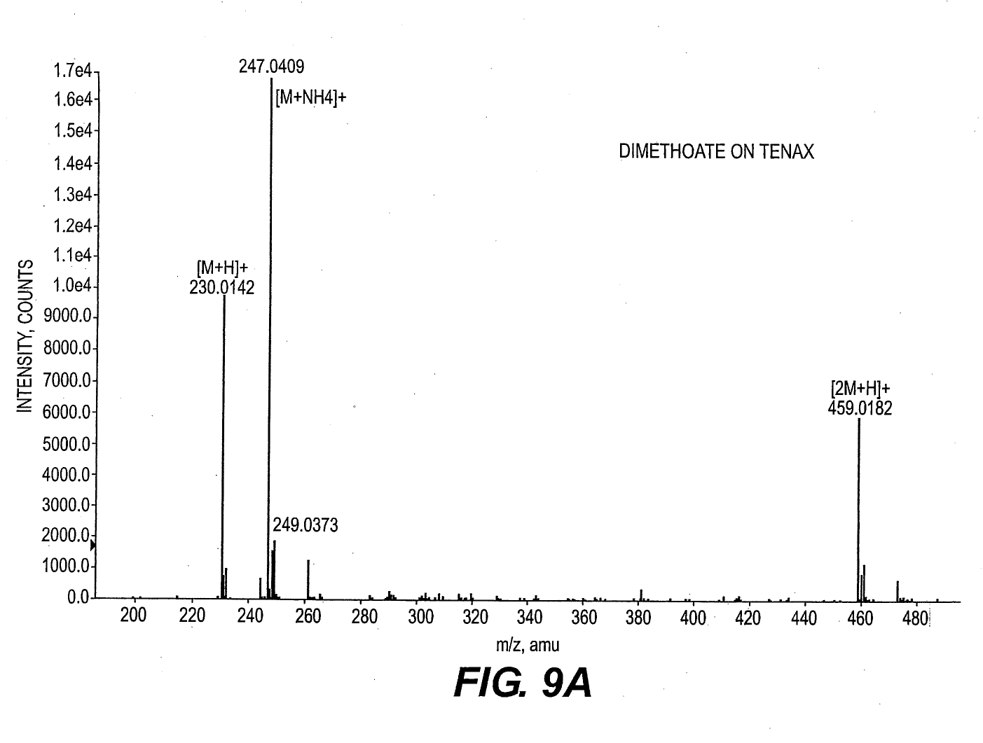

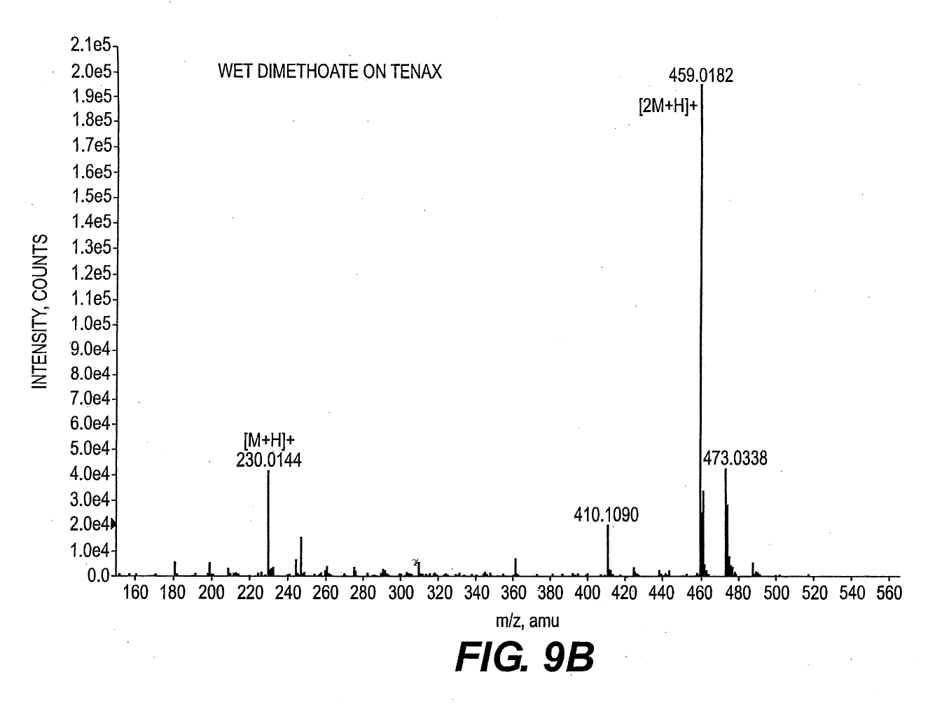

FIGS. 9A and 9B are diagrams showing DART/MS detection of the pesticide dimethoate vapor sorbed onto dry Tenax TA (FIG. 9A) and wet Tenax TA (FIG. 9B).

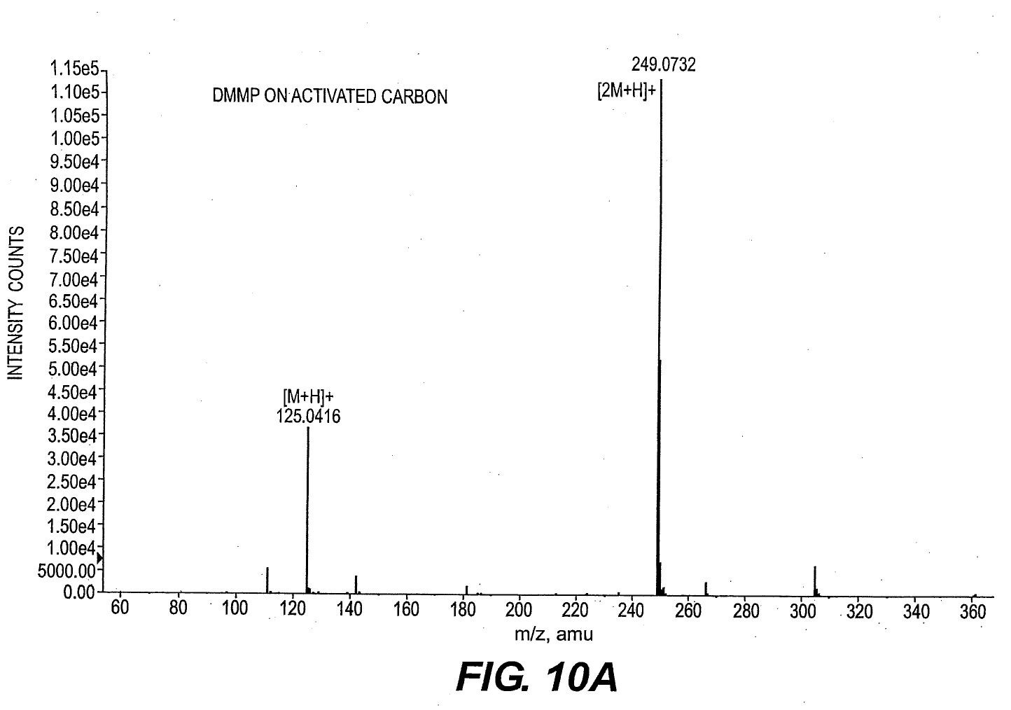

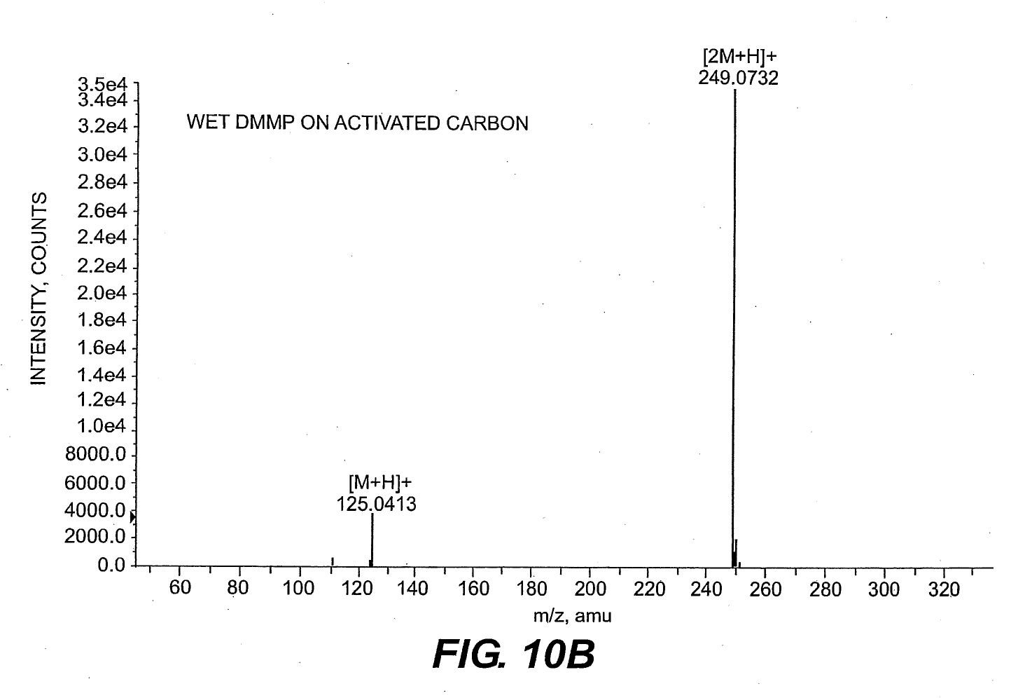

FIGS. 10A and 10B are diagrams showing DART/MS detection of DMMP vapor sorbed onto dry charcoal (FIG. 10A) and wet charcoal (FIG. 10B).

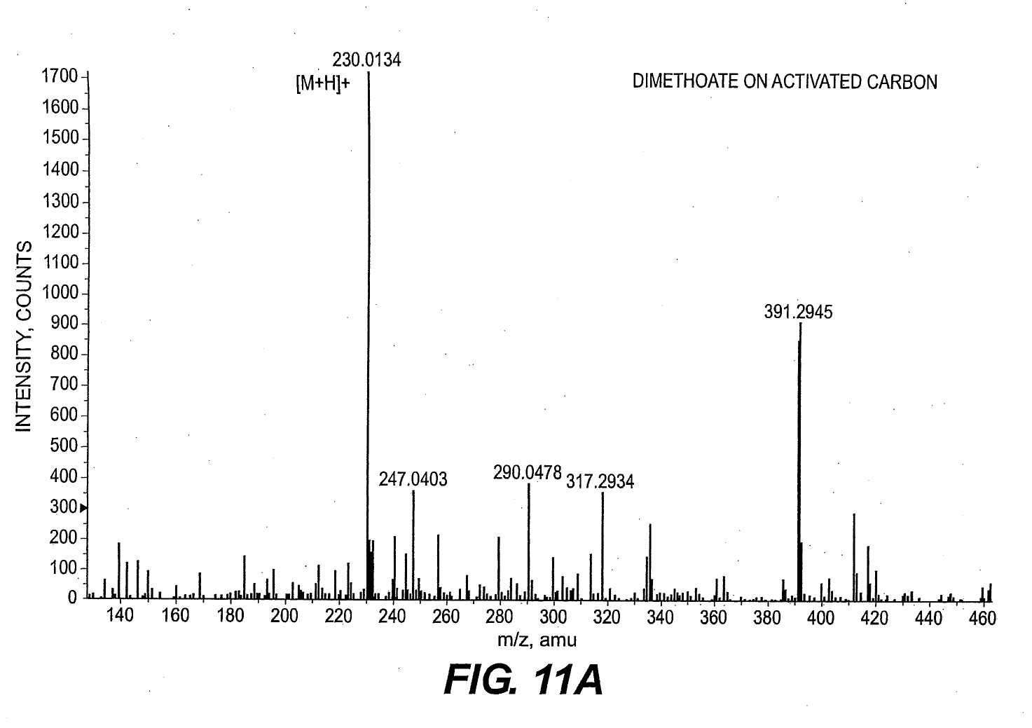

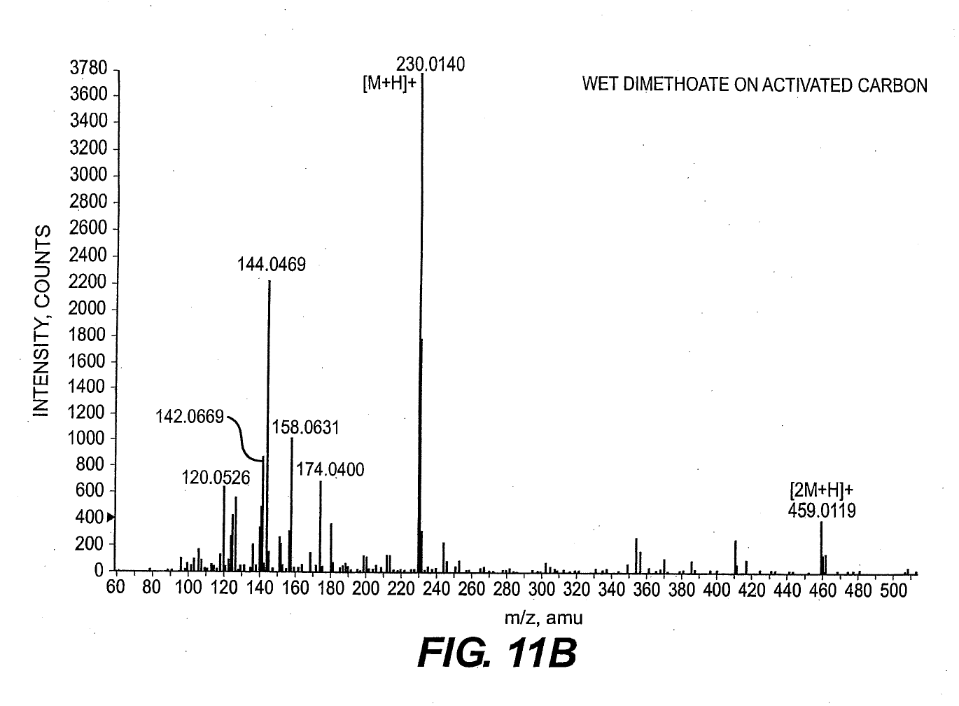

FIGS. 11A and 11B are diagrams showing DART/MS detection of dimethoate vapor sorbed onto dry charcoal (FIG. 11A) and wet charcoal (FIG. 11B).

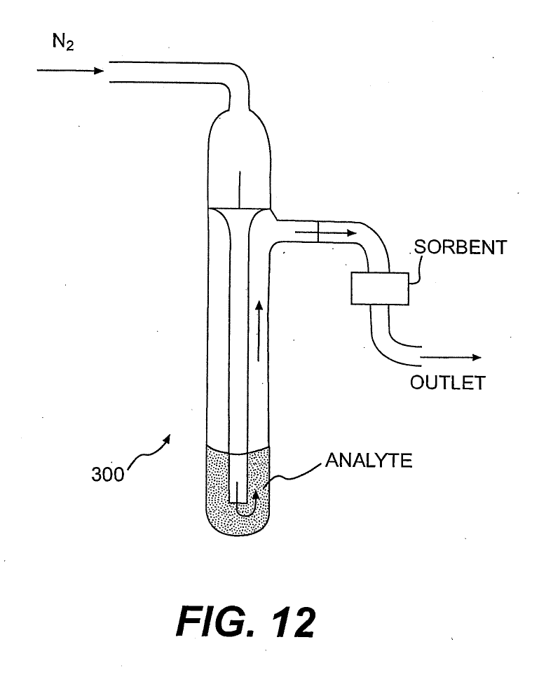

FIG. 12 is a diagram showing an Apparatus for chemical vapor adsorption experiments.

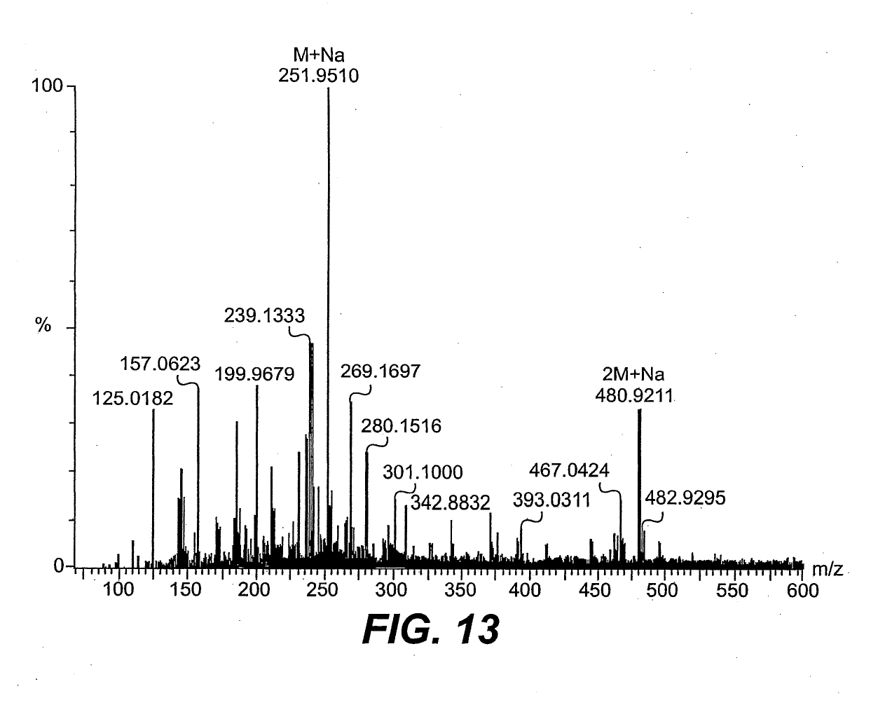

FIG. 13 is a diagram showing Desorption Electrospray Ionization/Mass Spectrometry (DESI/MS) detection of DMMP vapor sorbed onto Tenax TA.

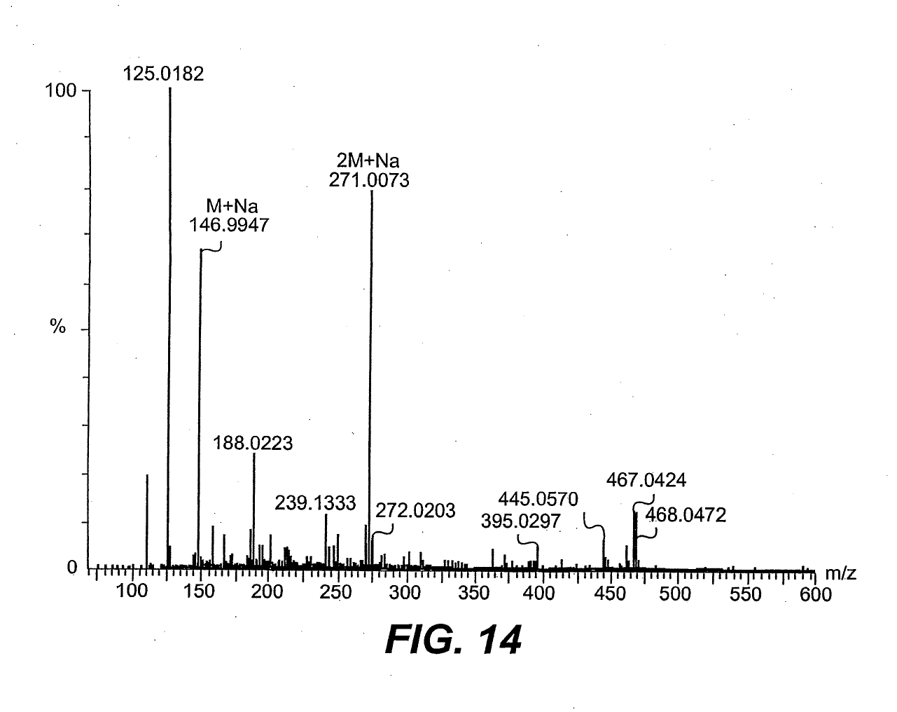

FIG. 14 is a diagram showing DESI/MS detection of dimethoate vapor sorbed onto Tenax TA.

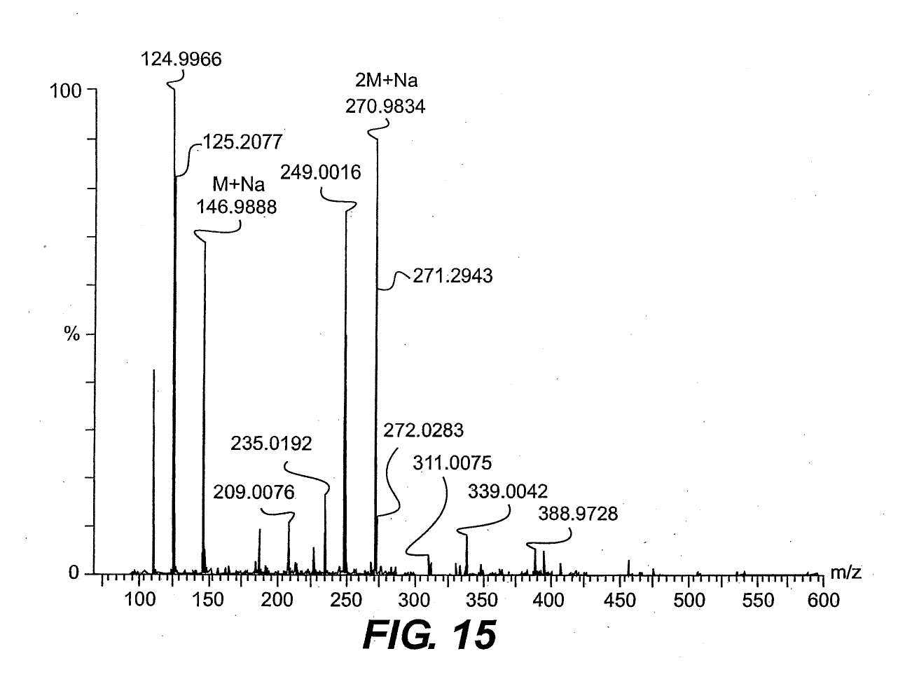

FIG. 15 is a diagram showing DESI/MS detection of DMMP vapor sorbed onto charcoal.

### DETAILED DESCRIPTION OF THE INVENTION

One aspect of the subject matter described herein relates to a method for detecting a chemical of interest in a fluid sample. Referring now to FIG. 1, an embodiment of the method 100 includes passing (110) a fluid sample through a sorbent material that adsorbs or collects chemical vapors, particles and aerosols from the fluid sample; desorbing and ionizing (120) the chemicals adsorbed/collected on the sorbent material using an atmospheric pressure ionization technique; detecting (130) the ions generated by said atmospheric pressure ionization technique, and producing (140) an alarm when a chemical of interest is detected.

The chemical of interest may be any chemical molecule that can be ionized by atmospheric pressure ionization techniques. Examples of such chemicals of interest include, but are not limited to, chemical warfare agents (CWA), non-traditional agents (NTAs), dusty agents (DAs), toxic industrial chemicals (TICs), explosives and their related compounds, and residues thereof.

Examples of CWAs include, but are not limited to, nerve agents such as GA (Tabun, ethyl N,N-dimethyl phosphoramidocyanidate), GB (Sarin, isopropyl-methylphosphorofluoridate), GD (Soman, Trimethylpropylmethylphosphorofluoridate), GF (cyclohexyl-methylphosphorofluoridate) and VX (o-ethyl S-[2-(diiospropylamino)ethyl]methylphosphorofluoridate); vesicants such as HD (mustard, bis-2-chlorethyl sulfide), CX (Phosgene oxime, dichloroformoxime), and L (Lewisite, J-chlorovinyldichloroarsine); cyanides such as AC (Hydrocyanic acid) and CK (Cyanogen chloride); pulmonary agents such as CG (phosgene, carbonyl chloride) and DP (Diphosgene, trichloromethylchlorformate).

NTAs and DAs are CWAs dispersed as either a liquid or particulate aerosol. For example, dusty mustard is composed of mustard agent (liquid) dispersed onto fine particulates of silica.

Examples of TICS can be found in the U.S. Environmental Protection Agency's reference list of toxic compounds (Alphabetical Order List of Extremely Hazardous Substances” Section 302 of EPCRA).

Examples of explosives detectable by the embodiments described herein include, but are not limited to, nitroglycerin-based powders, ammonium nitrate/fuel oil mixtures (ANFO), Trinitrotoluene (TNT), Pentaerythritoltetranitrate (PETN), Cyclotrimethylenetrinitramine (RDX), and Cyclotetramethylene-tetranitramine (HMX). Explosive related compounds include, but are not limited to, residual raw materials, manufacturing byproducts and degradation products.

The term “residue,” as used in the embodiments described herein, refers to a small amount of a substance, or a material associated with that substance. A residue may not directly be the substance whose detection is desired, but may be a substance indicative of the presence of the substance whose detection is desired. For example, a residue of a chemical agent may be a degradation product of the chemical agent, a chemical binder used to particulate a gaseous CWA, or a substrate on which a CWA is ordinarily placed.

The term “fluid,” as used in the embodiments described herein, refers to a substance that continually deforms (flows) under an applied shear stress regardless of how small the applied stress. Fluids are a subset of the phases of matter and include liquids, gases, aerosols (particles in a gas stream), plasmas and, to some extent, solids.

The thin layer of sorbent material is incorporated in a sample collection device designed for collection of chemical vapors, particles and aerosols from the fluid sample and subsequent atmospheric pressure ionization for identification of chemicals by an ion detector.

Referring now to FIG. 2A, an embodiment of the sample collection device 10 includes a thin layer of sorbent material 12 and a housing 14. The housing 14 has two openings 15 and 16 to allow a fluid sample to enter and exit the housing 14. The sorbent material 12 is in the form of a thin layer and is placed between the openings 15 and 16 so that a fluid sample passing through the housing 14 via the openings 15 and 16 also passes through the sorbent material 12. The sorbent material 12 is a porous material that is capable of adsorbing the chemical vapors. In one embodiment, the sorbent material 12 is a material that preferentially collects a specific chemical vapor or class of chemical vapors and rejects many background chemical vapors. In another embodiment, the sorbent material 12 is a material that collects a broad range of chemical vapors. In another embodiment, the sorbent material 12 is also capable of collecting airborne particles and aerosols. The sorbent material 12 can be, but is not limited to, commercial off-the shelf pre-concentration media commonly used to pre-concentrate chemical vapors prior to analysis. Examples of the sorbent material 12 include, but are not limited to, porous polymer resins, liquid polymers, sorbent carbons, nanotube materials, cellulose based materials, inorganic based sorbents and combinations thereof.

Examples of porous polymer resins include, but are not limited to, Tenax® (2,6-diphenylene oxide), PIB (poly(isobutylene)), SXPH (75% phenyl-25% methylpolysiloxane), PEM (polyethylene maleate), SXCN (poly bis(cyanopropyl) siloxane), PVTD (poly (vinyltetradecanal)), PECH (poly(epichlorohydrin)), PVPR (poly(vinyl propionate)), OV202 (poly(trifluoropropyl)methyl siloxane), P4V (poly(4-vinylhexafluorocumyl alcohol)), SXFA (1-(4-hydroxy, 4-trifluoromethyl,5,5,5-trifluoro)pentene methylpolysiloxane), FPOL (fluoropolyol), PEI (poly(ethyleneimine), SXPYR (alkylaminopyridyl-substituted siloxane), and polysilsesquioxane. In one embodiment, the sorbent material is Tenax®.

Examples of liquid polymers include, but are not limited to, polydimethylsiloxane (PDMS).

Examples of sorbent carbons include, but are not limited to, activated carbon, charcoal, carbon molecular sieves and graphite.

Examples of the inorganic based sorbents include, but are not limited to, zeolites and metal organic frameworks (MOFs). Zeolites are hydrated aluminosilicate minerals with a micro-porous structure. MOFs are porous polymeric materials, consisting of metal ions linked together by organic bridging ligands to form one-, two-, or three-dimensional porous structures.

Examples of the nanotube materials include, but are not limited to, single, double or multiwalled carbon nanotubes, derivatized single, double or multiwalled carbon nanotubes, and carbon nanotube product such as nanotube paper.

The term “nanotube,” as used in the embodiments described herein, refers to a hollow article having a narrow dimension (diameter) of about 1-200 nm and a long dimension (length), where the ratio of the long dimension to the narrow dimension, i.e., the aspect ratio, is at least 5. In general, the aspect ratio is between 10 and 2000.

The term “carbon-based nanotubes” or “carbon nanotubes,” as used hereinafter, refers to nanotube structures composed primarily of carbon atoms. The “carbon-based nanotube” or “carbon nanotubes,” includes derivatized carbon nanotubes and carbon nanotubes doped with other elements, such as metals.

The term “carbon nanotube product,” as used hereinafter, refers to cylindrical structures made of rolled-up graphene sheet, either single-wall carbon nanotubes or multi-wall carbon nanotubes.

The nanotube paper can be any form, including commercially available carbon nanotube paper, such as the BuckyPaper from Nanolab (Newton, Mass.).

Derivatized nanotubes comprise additional functional groups that bind to the chemicals of interest. For example, nanotube ends may be functionized with carboxylic groups (Rao, et al., Chem. Commun., 1996, 1525-1526; Wong, et al., Nature, 1998, 394:52-55), amine groups (Liu, et al., Science, 1998, 280:1253-1256), fluorine gas (U.S. Pat. No. 6,841,139), or diazonium (U.S. Pat. No. 7,250,147).

The sorbent material 12 for a particular application is selected based on the chemical of interest and the physical properties of the sorbent material 12. In order to reduce volume while maintaining a maximum contact area, the sorbent material 12 forms a thin layer such that there is a low pressure drop across the sample collection device 10. The thin layer of the sorbent material 12 may comprise a sorbent powder embedded in an inert matrix, a sorbent coating on a porous substrate, a sorbent film immobilized onto a mesh or screen support, or a mesh or screen made of the sorbent material 12 itself. In one embodiment, the sorbent material 12 is thermally reconditioned after each use (i.e., regenerated by heating at certain temperatures). In another embodiment the sorbent material 12 is reconditioned after each use by exposure to an atmospheric ionization source or a thermal source.

The housing 14 of the sample collection device 10 is customarily designed for each specific application and has a configuration that facilitates subsequent interrogation by an atmospheric pressure desorption/ionization technique. Referring now to FIG. 2B, in one embodiment, the openings 15 and 16 are covered with a wire mesh or a screen 17 to contain the sorbent material 12 in the housing 14. In an embodiment shown in FIGS. 3A and 3B, the sample collection device 10 further includes two wire meshes or screens 19 that hold the sorbent material 12 in between. The openings 15 and 16 allow the fluid sample to flow through the sorbent material 12. In one embodiment, the wire meshes or screens 19 are also used as an electrostatic collection device to enhance the aerosol sample collection efficiency of the sample collection device 10.

In another embodiment, the sorbent material 12 is in a powder form and is embedded inside an inert matrix 18 (FIG. 4) to form a sorbent cartridge 11 that fits into the housing 14. The sorbent cartridge 11 can be easily replaced after exposure to a fluid sample. This replacibility allows the housing 14 to be re-used. Examples of the inert matrix include, but are not limited to, plastic matrix such as fluorine-containing polymers (e.g., Teflon®) and high density polyethylene, and metal matrix such as open-cell metal foams made from aluminum or stainless steel. In one embodiment, the sorbent material 12 is carbon nanotube powder or Tenax™ TA powder.

In another embodiment, the cartridge 11 comprises a mesh screen, metal foam, or fibers coated with a thin layer of sorbent material 12. The thin layer of the sorbent material 12 may have an average thickness in the range of 1 μm to 1 mm.

In yet another embodiment, the sample collection device contains a mesh or screen made of the sorbent material 12 itself.

Chemicals in a fluid sample, such as an air sample, are collected/sorbed by passing the sample through the sample collection device 10 for a given period of time so that the sorbent material the sample collection device 10 adsorbs or collects chemical vapors, particles and aerosols from the fluid sample (i.e., passing (110) a fluid sample through a sorbent material that adsorbs or collects chemical vapors, particles and aerosols from the fluid sample). The sorbent material 12 in the sample collection device 10 will then be interrogated by an atmospheric pressure desorption/ionization technique for the desorption, ionization and subsequent detection of the chemical vapors collected (i.e., desorbing and ionizing (120) the chemicals adsorbed/collected on the sorbent material using an atmospheric pressure ionization technique). In one embodiment, the sorbent material 12 is taken out of the sample collection device 10 after sampling, and interrogated immediately by an atmospheric pressure ionization source and detection device. In another embodiment, the sorbent material 12 is taken out of the sample collection device 10 after sampling, stored in a sealed container, and analyzed later. As described above, the sorbent material 12 may be embedded in a inert matrix 18 to form a cartridge 11 to facilitate the replacement and storage of the sorbent material 12. In another embodiment, the sample collection device 10 has a configuration that allows the analysis device 20 to analyze the sorbent material 12 without first taking the sorbent material 12 out of the sample collection device 10. In yet another embodiment, the sample collection device 10 itself is made in a cartridge form so that the sample collection device 10 can be easily replaced, stored, or transferred to the atmospheric pressure ionization source and detection device. The ions generated by the atmospheric pressure ionization technique is then analyzed by an ion analyzer (i.e., detecting (130) the ions generated by said atmospheric pressure ionization technique). If the chemical of interest is detected in the ions generated by the atmospheric pressure ionization technique, the detection device may produce an alarm to draw the attention of the operator of the device (i.e., producing (140) an alarm when a chemical of interest is detected).

Referring now to FIG. 5, which shows an embodiment of a chemical sample collection and detection system. In this embodiment, the chemical sampling and detection system 200 includes sample collection device 10, a detection device 20 that analyzes the sample collected/sorbed onto the sorbent material 12 of the collection device 10 using an atmospheric pressure desorption/ionization technique, and a control device 30 that controls the chemical sample collection and detection system 200, and generate an output. In one embodiment, the sample collection device 10 is a passive collection device. The sample passes through the sample collection device 10 by diffusion. In another embodiment, the chemical sampling and detection system 200 further includes an auxiliary sample collection device 40 that facilitates sample flow in the sample collection device 10. For example, the auxiliary sample collection device 40 may contain a pump or a fan to move air through the sorbent material 12 in the sample collection device 10. The functions of the auxiliary sample collection device 40 may also include, but are not limited to, maintaining the sample collection device 10 at a desired temperature, collecting aerosol samples, delivering the sample collection device 10 to the detection device 20 for further analysis after the sampling period, and flushing, regenerating or replacing the sample collection device 10 after each sampling period.

In one embodiment, the detection device 20 includes an atmospheric pressure ionization source 22 and an ion detector 24. Examples of atmospheric pressure ionization sources 22 include, but are not limited to, Direct Analysis in Real Time (DART) ion sources, Plasma Assisted Desorption/Ionization (PADI), Desorption Electrospray Ionization (DESI), Desorption Atmospheric Pressure Chemical Ionization (DAPCI), Electrospray-assisted Laser Desorption/Ionization (ELDI), Desorption Sonic Spray Ionization (DeSSI), Desorption Atmospheric Pressure Photoionization (DAPPI), Fission Fragment Ionization (FFI), atmospheric pressure matrix assisted laser desorption ionization (AP-MALDI), atmospheric sampling analysis probe (ASAP), matrix assisted laser desorption electrospray ionization (MALDESI), electrospray ionization (ESI) combined with laser, laser diode thermal desorption (LDTD) or thermal desorption, atmospheric pressure chemical ionization (APCI) combined with laser, laser diode thermal desorption (LDTD) or thermal desorption, and atmospheric pressure photoionization (APPI) combined with laser, laser diode thermal desorption (LDTD) or thermal desorption.

A DART ion source refers to an atmospheric-pressure ion source that permits analysis of gases, liquids, solids, or materials on surfaces in open air at ground potential under ambient conditions. The DART ion source operates by exposing the sorbent material 12 to a dry gas stream (typically helium or nitrogen) that contains long-lived electronically or vibronically excited neutral atoms or molecules (or “metastables”) that are formed in the DART source by creating a glow discharge in a chamber through which the gas flows.

The excited-state species can interact directly with the chemical species adsorbed onto the sorbent material 12 to desorb and ionize the said chemical species. This process is referred to as Penning ionization, a reaction between an excited-state neutral atom or molecule M* and a substrate S that has an ionization potential with a lower energy than the internal energy of the excited-state species, resulting in the formation of a substrate radical molecular cation S⁺ and an electron e⁻:

M*+S→S⁺+e⁻

The helium 2³S state has an internal energy of 19.8 electron volts, which is sufficient to ionize most organic molecules. Alternatively, the excited-state species can interact with atmospheric gases such as water and oxygen to form reagent ions that undergo chemical ionization reactions that result in ionization of the chemical agent absorbed in the sorbent material 12.

He(2³S)+H₂O→H₂O^{+*}+He(1¹S)+e⁻

H₂O^{+*}+H₂O→H₃O⁺+OH^{*}

H₃O⁺+nH₂O→(H₂O)ₙ₊₁H⁺

(H₂O)ₙ₊₁H⁺+M→MH⁺+nH₂O

In negative-ion mode, electrons e⁻ are thermalized by collisions with gas molecules, G. Atmospheric oxygen captures an electron and reacts with the sample to produce negative ions.

e⁻G→e⁻+G*

e⁻+O₂→e⁻+O₂^{-*}

O₂^{-*}+S→[S−H]⁻+OOH^{*}

Exposure to excited-state species assists in desorbing and ionizing (120) chemical species from surfaces. The DART gas stream can also be heated to enhance desorption and/or to decompose chemicals to produce characteristic fragments that can be used for identification.

Similar to DART, PADI also uses a plasma for ionization but there are several crucial differences. The DART plasma is formed by a glow discharge held away from the surface of the sorbent material 12. Charged species are removed to leave a beam of metastable species to hit surface of the sorbent material 12. In contrast, PADI employs an atmospheric glow discharge which is held in direct contact with surface of the sorbent material 12. The ions formed in this plasma are far less energetic than those in the DART discharge and are allowed to remain in the plasma. The reduced energy means that the plasma does not heat the surface of the sorbent material 12, so thermally sensitive chemicals can be studied.

DESI is carried out by directing pneumatically assisted electrosprayed charged droplets onto the surface of sorbent material 12 at atmospheric conditions. The charged droplets pick up the chemicals adsorbed onto the sorbent material 12 and then form highly charged ions that can be analyzed by an ion detector. The contents of the solvent spray, the gas flow rate, the amount of applied voltage, the spray angle and the ion uptake angle, as well as the various distances in aligning the spray, sample and the ion analyzer are all variables which can be studied to achieve an optimal spectrum for a particular type of chemical. DESI has been used to directly interrogate a diverse range of surfaces. A wide range of molecules, including explosives and chemical warfare agents, have been successfully ionized using DESI.

DAPCI uses a flow of solvent vapor and a corona discharge to affect ionization. With atmospheric solids analysis probe (ASAP), a jet of heated gas is directed at the surface of the sorbent material 12 to desorb the chemical(s) adsorbed onto the sorbent material 12. The desorbed chemical(s) is ionized by corona discharge.

ELDI relies on a laser to desorb material into an electrospray plume. With matrix-assisted laser desorption electrospray ionization (MALDESI), a laser is used to desorb material into the electrospray. MALDESI has been used with MALDI matrix materials. Laser ablation electrospray ionization (LAESI) uses an infrared laser for ablation of the sample material.

DeSSI uses sonic spray ionization to form the ions that are directed at the surface of the sorbent material 12.

DAPPI uses a jet of heated solvent for desorption and ultraviolet light for photoionization.

FFI is an ionization technique in which ionization of material in a solid sample is achieved by bombarding it with ionic or neutral atoms formed as a result of the nuclear fission of a suitable nuclide, typically the Californium isotope ²⁵²Cf.

MALDI is a soft ionization technique for the analysis of biomolecules (biopolymers such as proteins, peptides and sugars) and large organic molecules (such as polymers, dendrimers and other macromolecules), which tend to be fragile and fragment when ionized by more conventional ionization methods. The ionization is triggered by a laser beam (normally a nitrogen laser). A matrix is used to protect the biomolecule from being destroyed by direct laser beam and to facilitate vaporization and ionization. The matrix typically consists of crystallized molecules that have a low molecular weight to allow facile vaporization, but are large enough not to evaporate during sample preparation. The matrix molecules are acidic, therefore act as a proton source to encourage ionization of the analyte. The matrix molecules have a strong optical absorption in the UV, so that they rapidly and efficiently absorb the laser irradiation. The matrix molecules may also be functionalized with polar groups, allowing their use in aqueous solutions.

Using an atmospheric pressure desorption/ionization method such as DART or DESI, adsorbed chemical(s) can then be desorbed and ionized (120) and analyzed (130) directly from the sample collection device 10. Once sufficiently analyzed, the sorbent material 12 within the collection device 10 can be disposed of or regenerated (i.e. thermally reconditioned), allowing for subsequent samples to be collected and analyzed. Alternatively, analyzed sorbent material 12 may be archived for future reference. In one embodiment, outlined in FIGS. 6A-6C, several collection devices 10 (FIG. 6A) are packaged together as a carousel or compact disk to enable an automated, high throughput sample collection and detection system (FIGS. 6B and 6C). The automated collection system continuously collects and pre-concentrates discrete fluid samples. The detection device 20 desorbs and ionizes (120) and detects (130) the chemical constituents of each sample and regenerates the sorbent material 12 for subsequent samples. This configuration enables continuous air monitoring for a broad range of chemical vapors and aerosols with minimal user intervention.

The desorbed and ionized chemical(s) is detected (130) by the ion detector 24 using a number of charged ion detection technologies. Examples of ion detection technologies include, but are not limited to, mass spectrometers with different mass analyzers (such as quadrupole, time of flight, ion trap, etc), ion mobility spectrometers, and differential ion mobility spectrometers and tandem techniques such as ion mobility spectrometry-mass spectrometry.

The detection system may be purged after each use. In one embodiment, ambient air is used for system purges so that no on-board gas containers or gas generators are needed.

The control device 30 provides coordination and communication of the components in the chemical sampling and detection system 200. The control device 30 is designed to: (a) provide a single user interface to the entire system 200; (b) allow a user to quickly determine the status of all components associated with the system; and (c) accept input to change parameters which allow for the configuration changes, and (d) indicate detection of a chemical of interest and produce an alarm. At its most basic level, the control device 30 provides an alarm when a target chemical is identified by the ion detector 24.

In one embodiment, the control device 30 includes a memory 32, a controller 34, and an external port 36. The memory 32 may be used to store libraries of signature fingerprints of chemicals and operation software. In one embodiment, the memory 32 is a flash memory. The controller 34 monitors and controls the operation of the chemical vapor sampling and detection system 100 and provides an interface to the user about the status of the overall system. For example, the controller 34 may stage the timing, temperature and air flow rate of the sample collection device 10, and compare the results from the detection device 20 with the libraries of fingerprint of chemicals in the memory 32 to identify the target chemical and reduce false positives.

In one embodiment, the controller 34 is small, lightweight and available as a standard commercial off-the-shelf (COTS) product. In another embodiment, the controller 34 is a COTS offering and is packaged as a microbox PC with a passive PCI bus backplane. This configuration allows the component modularity for easy upgrades as computer hardware technologies improve. In another embodiment, the controller 34 resides on a single board computer (SBC) that already have its peripheral interfaces built in: PCI bus, Ethernet, and RS-232 serial. Flash memory and DRAM can be sized to the control system requirements with removable memory sockets on the SBC. Communication from the controller 34 to the other components of the chemical sampling and detection system 200 is handled by COTS data acquisition, digital input/output, and analog input/output circuit cards that are PCI bus compatible.

The external port 36 is used for downloading software upgrades to the memory 32 and performing external trouble-shooting/diagnostics. In one embodiment, the chemical sampling and detection system 200 is powered by a long-life battery or batteries that can be recharged and reused. Preferably, the batteries are interchangeable with batteries from other Northrop Grumman portable systems.

In another embodiment, field-programmable gate array (FPGA) technology is used for monitors and control circuits in order to keep the weight, size, and especially power consumption at a minimum. The FPGA technology also affords minimum hardware redesign impact when implementing system upgrades.

In yet another embodiment, the control device 30 is networked to multiple collection devices 10 and/or multiple detection device 20 located at a particular site.

### EXAMPLES

The following specific examples are intended to illustrate the collection and detection of representative chemicals using methods and devices described in the embodiments. The examples should not be construed as limiting the scope of the claims.

### Example 1

### DART Analysis of Chemical Vapors Sorbed onto Tenax™ TA

DART ionization is used to ionize chemical vapors or solid/liquid particles collected/sorbed onto the surface of a sorbent material. Ions generated by DART are then directed into the inlet of a mass spectrometer. The DART studies utilized the sample collection device shown in FIGS. 7A and 7B. A small amount of sorbent was held between two pieces of wire mesh using either a Swagelok fitting or a custom designed apparatus. Samples of the sorbent, in this case Tenax™ TA (poly(2,6-diphenyl-1,4-phenylene oxide), were exposed to the analyte vapor by placing a small amount of sorbent into a vessel containing the chemical vapor. The system was sealed and allowed to equilibrate such that the sorbent adsorbs the target chemical vapor. After equilibration, the sorbent was removed from the container and a small amount placed between the screens in the sample collection device outlined in FIGS. 7A and 7B. The sample collection device was placed into the DART stream. The ionized species were analyzed using a time-of-flight mass spectrometer (TOFMS). All spectra in this series required less than 5 seconds to acquire.

FIGS. 8A and 8B compare the DART analysis of the nerve agent simulant dimethyl methylphosphonate (DMMP) vapor sorbed onto dry and wet Tenax™ TA. Tenax™ TA is a common sorbent material used for collection and analysis of chemical warfare agent (CWAs) vapors. FIG. 8A shows the DART analysis of DMMP vapor sorbed on the Tenax TA with no added water. The [M+H]⁺ ion at mass 125.0418 m/z (here M=DMMP) and the dimer [2M+H]⁺ ion at mass 249.0741 m/z are the strongest peaks in the mass spectrum. FIG. 8B shows the DART analysis of DMMP vapor sorbed onto wet Tenax™ TA. Here the same ions at 125.0418 m/z and 125.0418 m/z are readily seen as in the case of the dry Tenax™ TA demonstrating the capability of the DART ionization approach to successfully remove an analyte from a sorbent in the presence of water which current thermal desorption technology is not capable of doing.

FIGS. 9A and 9B show the same study performed on the low vapor pressure pesticide dimethoate (O,O-dimethyl S-[2-(methylamino)-2-oxoethyl] dithiophosphate) which exhibits a vapor pressure of 10⁻⁶ Torr. FIG. 9A shows the DART analysis of dimethoate vapor sorbed onto dry Tenax™ TA. Three major ion peaks, [M+H]⁺ at 230.0142 m/z, [M+NH₄]⁺ at 247.0409 m/z, and the dimer [2M+H]⁺ at 459.0182 m/z, were detected. FIG. 9B shows the DART analysis of dimethoate vapor sorbed onto wet Tenax™ TA. Here two ions, [M+H]⁺ at 230.0142 m/z and the dimer [2M+H]⁺ at 459.0182 m/z are seen indicating that the DART analysis can ionize the dimethoate in the presence of water without causing degradation via hydrolysis.

### Example 2

### DART Analysis of Chemical Vapors Sorbed onto Activated Charcoal

Activated carbon is traditionally used as a filter material for many chemical warfare agents due to its ability to tightly bind these agents. However, this binding strength makes it difficult to desorb and release these chemical species for analysis since heating the activated carbon can readily lead to analyte decomposition. FIGS. 10A and 10B show DART analysis of DMMP vapor sorbed onto dry and wet activated carbon. FIG. 10A shows the DART analysis of DMMP from dry activated carbon exhibits two peaks, the [M+H]⁺ ion at mass 125.0418 and the dimer [2M+H]⁺ ion at mass 249.0741 m/z. FIG. 10B shows the DART analysis of DMMP vapor sorbed onto wet activated carbon. The same two peaks, [M+H]⁺ ion at mass 125.0418 and the dimer [2M+H]⁺ ion at mass 249.0741 m/z, are observed using the DART analysis approach. These figures demonstrate the capability of an atmospheric pressure ionization approach, such as DART, to rapidly analyze chemicals sorbed onto activated carbon in the presence of water without significant hydrolysis of the analyte.

FIGS. 11A and 11B show the DART analysis of the pesticide dimethoate vapor sorbed on dry and wet activated charcoal. FIG. 11A shows the results for dry activated carbon. Here a single peak [M+H]⁺ at 230.0134 m/z is the most intense peak. FIG. 11B shows the DART analysis of dimethoate vapor sorbed on wet activated charcoal. Two peaks, the [M+H]⁺ peak at 230.0134 m/z and the dimer peak [2M+H]⁺ at 459.0182 m/z, were detected. This data clearly demonstrates that DART analysis of wet charcoal can readily be performed.

### Example 3

### DESI Analysis of Chemical Vapors Sorbed onto Tenax™ TA

DESI uses an electrosprayed solvent (such as 50:50 water:methanol solution, etc) to desorb and ionize the analyte from a surface. Analyte ions generated by DESI are then directed into the detector inlet of an ion detector.

Samples for the DESI experiments were prepared by first exposing the sorbent to different chemical vapors. The setup used for vapor exposure is shown in FIG. 12 and consists of a bubbler 300 containing the chemical liquid which feeds into a tube that contains a small amount of sorbent (significantly less sorbent than used in a traditional packed bed sorbent tube). Inert gas (such as nitrogen) was bubbled through the liquid and the vapor produced carried to the sorbent where it was captured/sorbed for analysis. After exposure the sorbent was transferred to a microscope slide using double sided tape. The slide was loaded onto the DESI sample area and the DESI stream brought to bear onto the sorbent. As with the DART, analysis of the sorbed samples was very rapid, requiring less than 5 seconds to acquire the data.

FIG. 13 shows the DESI analysis of the nerve agent simulant dimethyl methylphosphonate (DMMP) vapor sorbed onto the sorbent material Tenax™ TA. Two peaks, one corresponding to the [M+Na]⁺ ion at 146.9947 m/z and the dimer [2M+Na]^{+ at} 271.0073 m/z are the strongest peaks in the mass spectrum. DESI analysis of a compound captured by a sorbent will not be affected by the presence of water because, as in the experiment shown in FIG. 8, the DESI solvent is a 50/50 mixture of water and acetonitrile. The sodium ion originates from sodium chloride also present in the DESI solvent.

FIG. 14 shows the same study performed on the low vapor pressure pesticide dimethoate (O,O-dimethyl S-[2-(methylamino)-2-oxoethyl] dithiophosphate) which exhibits a vapor pressure of 10⁻⁶ torr In FIG. 13 the DESI analysis of dimethoate vapor sorbed onto Tenax™ TA shows two ions, [M+Na]⁺ at 251.9510 m/z, and the dimer [2M+Na]⁺ at 480.9211 m/z. The fact that these ions are seen indicates that the DESI analysis desorbs and ionizes the dimethoate (as the positive ion) without causing degradation via hydrolysis.

### Example 4

### DESI Analysis of Chemical Sorbed onto Activated Charcoal

As in the DART experiments, the DESI was used to acquire mass spectra of DMMP vapor sorbed onto charcoal. As previously mentioned, charcoal sorbs many chemicals very tightly such that some chemical species are thermally degraded before they can be efficiently desorbed from charcoal by heat. As in the case of the DART experiment on charcoal, the mass spectrum of DMMP vapor sorbed onto charcoal was obtained using the DESI ionization approach. FIG. 15 shows the DESI/MS spectrum of DMMP vapor sorbed onto charcoal. Two peaks due to DMMP are present, the [M+Na]⁺ positive ion at 146.9888 m/z and the dimer [2M+Na]⁺ at 270.9834 m/z.

The foregoing discussion discloses and describes many exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1-23. (canceled)

24. A method for detecting a chemical in a fluid sample, comprising:
passing said fluid sample through a sorbent material that adsorbs chemical vapors, and traps particles and aerosols in said fluid sample;
desorbing and ionizing chemicals adsorbed or trapped on said sorbent material using an atmospheric pressure ionization technique; and
detecting said chemical in ions generated by said atmospheric pressure ionization technique.

25. The method of claim 24, further comprising:
producing an alarm when said chemical is detected.

26. The method of claim 24, wherein said sorbent material is selected from the group consisting of porous polymer resins, sorbent carbons, cellulose based materials, liquid polymers, metal organic frameworks, inorganic based sorbents, carbon nanotubes, and combinations thereof.

27. The method of claim 24, wherein said a thin layer of sorbent material comprises a mesh or screen coated with a sorbent material.

28. The method of claim 24, wherein said a thin layer of sorbent material comprises a porous matrix coated with a sorbent material.

29. The method of claim 28, wherein said porous matrix comprises a material selected from the group consisting of polymeric materials and metal foams.

30. The method of claim 29, wherein said polymeric material is a fluorine-containing polymer or a high density polystyrene.

31. The method of claim 24, wherein said a thin layer of sorbent material comprises a sorbent powder embedded inside an inert matrix.

32. The method of claim 31, wherein said inert matrix comprises a material selected from the group consisting of polymeric materials and metal foams.

33. The method of claim 31, wherein said sorbent powder is selected from the group consisting of porous polymer resins, sorbent carbons, cellulose based materials, liquid polymers, metal organic frameworks, inorganic based sorbents, carbon nanotubes, and combinations thereof.

34. The method of claim 24, wherein said atmospheric pressure ionization technique is selected from the group consisting of direct analysis in real time (DART) ion source, plasma assisted desorption/ionization (PADI), desorption electrospray ionization (DESI), desorption atmospheric pressure chemical ionization (DAPCI), electrospray-assisted laser desorption/ionization (ELDI), desorption sonic spray ionization (DeSSI), desorption atmospheric pressure photoionization (DAPPI), atmospheric pressure matrix assisted laser desorption ionization (AP-MALDI), atmospheric sampling analysis probe (ASAP), matrix assisted laser desorption electrospray ionization (MALDESI), fission fragment ionization (FFI), electrospray ionization (ESI) combined with laser, laser diode thermal desorption (LDTD) or thermal desorption, atmospheric pressure chemical ionization (APCI) combined with laser, laser diode thermal desorption (LDTD) or thermal desorption, and atmospheric pressure photoionization (APPI) combined with laser, laser diode thermal desorption (LDTD) or thermal desorption.

35. The method of claim 24, wherein said atmospheric pressure ionization technique is DART.

36. The method of claim 24, wherein said atmospheric pressure ionization technique is DESI.

37. The method of claim 24, wherein said sorbent material comprises activated charcoal.

38. The method of claim 24, wherein said sorbent material comprises poly(2,6-diphenyl-1,4-phenylene oxide).

39. A method for detecting a chemical in a fluid sample, comprising:
passing said fluid sample through a thin layer of sorbent material sandwiched between two wire meshes or screens, said sorbent material adsorbs chemical vapors, and traps particles and aerosols in said fluid sample;
desorbing and ionizing chemicals adsorbed or trapped on said sorbent material using DART or DESI; and
detecting ionized chemicals with a mass spectrometer.

40. The method of claim 39, wherein said sorbent material comprises activated charcoal.

41. The method of claim 39, wherein said sorbent material comprises poly(2,6-diphenyl-1,4-phenylene oxide).

42. The method of claim 39, wherein said mass spectrometer is a time-of-flight mass spectrometer.

43. The method of claim 39, wherein said thin layer of sorbent material has a thickness of about 1 μm to about 1 mm.
